(19) United States
(12) Patent Application Publication
(10) Pub. No.: US 2025/0322031 A1
(43) Pub. Date: Oct. 16, 2025

(54) SIGNAL PROCESSING DEVICE EFFICIENTLY IMPLEMENTING PERMUTATION AND FILTERING FOR INVERSE SPARSE FAST FOURIER TRANSFORM USED FOR GPS SIGNAL ACQUISITION AND PERMUTATION AND FILTERING METHOD THEREOF

(71) Applicant: UNIVERSITY OF SEOUL INDUSTRY COOPERATION FOUNDATION, Seoul (KR)

(72) Inventors: Kichul KIM, Seoul (KR); Giseon LEE, Anyang-si (KR); Jungi PARK, Seoul (KR)

(21) Appl. No.: 19/043,446

(22) Filed: Feb. 1, 2025

(30) Foreign Application Priority Data
Apr. 15, 2024 (KR) 10-2024-0050003

(51) Int. Cl. G06F 17/14; G06F 7/02

(52) U.S. Cl. CPC G06F 17/142; G06F 7/02

(57) ABSTRACT

A signal processing device for an inverse sparse fast Fourier transform performing permutation and filtering is disclosed. The signal processing device acquires a signal and converts the acquired signal into a time domain. The signal processing device comprises an input counter configured to give an index to the acquired signal; an address ROM configured to store signal information based on a predetermined first permutation parameter and a predetermined second permutation parameter used for a data order change; a comparator configured to check whether the index given to the acquired signal matches the signal information stored in the address ROM; an address counter configured to transmit an output signal to the address ROM when the comparator acquires a matching signal, and count a number of transmissions; a window memory configured to acquire different signals from the address ROM and output different window coefficients replaced in a minimal signed digit (MSD) representation representing a number in limited nonzero digits; and two multipliers configured to multiply the acquired signals by the window coefficients and output the signals.

### CROSS-REFERENCE TO RELATED APPLICATIONS

This application claims the benefit of Korea Patent Application No. 10-2024-0050003, filed on Apr. 15, 2024, which is incorporated herein by reference for all purposes as if fully set forth herein.

### TECHNICAL FIELD

Embodiments relate to a signal processing device efficiently implementing permutation and filtering for inverse sparse fast Fourier transform and a permutation and filtering method thereof.

### BACKGROUND

GPS systems are global navigation systems used to provide location information via satellites. The GPS systems perform communication using various frequency bands, and GPS signals used by civilians are defined and used in terms of L1 C/A, LIC, L2C, and L5 per frequency band. The L1 frequency band is used to provide location information and time information and is the most widely used frequency band in the GPS systems. The L5 frequency band is used to provide location information and timing information in the same manner as the L1 frequency band. The L5 signal provides a greater spreading gain by using higher transmit power and wider bandwidth than the L1 and L2 signals. However, a GPS receiver requires a higher sampling rate, and thus a fast Fourier transform (FFT) length of the L5 used to acquire the signals is longer than that of the L1 and L2.

For signals such as images or voices, a frequency domain often consists of only a very small number of valid values.

A sparse fast Fourier transform (SFFT) has been introduced to efficiently perform a FFT of the signal consisting of only a very small number of valid values.

The sparse fast Fourier transform essentially includes a permutation and filtering step, which consume the most time in the sparse fast Fourier transform (e.g., up to 79.8% of the time in all steps).

### PRIOR ART DOCUMENT

### Patent Document

Korean Patent Application Publication No. 10-2004-0016970 (published on Feb. 25, 2004) entitled “Method and device for calculating signal correlation in multiple analysis”
US Patent Application Publication No. US20140062779A1 entitled “Fast transform based offset determination”
Chinese Patent Application Publication No. CN105842713A “Ins (inertial navigation system) assisted fast acquisition method for bds (beidou navigation system) signals based on sft (sparse Fourier transform)”

### SUMMARY

An object of embodiments is to provide a signal processing device or signal processing method that performs communication of the same or similar quality as an existing one while reducing memory usage and increasing processing speed in a permutation and filtering step included in an inverse sparse fast Fourier transform.

In one aspect of the present disclosure, there is provided a signal processing device for an inverse sparse fast Fourier transform performing permutation and filtering, the signal processing device acquiring a signal and converting the acquired signal into a time domain, the signal processing device comprising an input counter configured to give an index to the acquired signal; an address ROM configured to store signal information based on a predetermined first permutation parameter and a predetermined second permutation parameter used for a data order change; a comparator configured to check whether the index given to the acquired signal matches the signal information stored in the address ROM; an address counter configured to transmit an output signal to the address ROM when the comparator acquires a matching signal, and count a number of transmissions; a window memory configured to acquire different signals from the address ROM and output different window coefficients replaced in a minimal signed digit (MSD) representation representing a number in limited nonzero digits; and two multipliers configured to multiply the acquired signals by the window coefficients and output the signals.

The signal information may include input index information for comparison with the index of the acquired signal, iteration position information indicating which iteration position the acquired signal is stored in, and a window bucket position indicating which window coefficient the acquired signal is multiplied by and is stored in which address of which buffer.

The predetermined first permutation parameter and the predetermined second permutation parameter may be determined so that a minimum number of multipliers are used by repeating the permutation and filtering.

The different window coefficients may include enable indicating information about whether a corresponding shift value is used; addition or subtraction indicating information about whether to perform an addition or a subtraction after a corresponding shift is performed; and a shift amount indicating information about how much the shift is to be performed.

The two multipliers may perform a multiplication using the minimal signed digit (MSD) representation representing the number in the limited nonzero digits.

Each of the two multipliers may only include a barrel shifter and an adder and may be a shift-and-add multiplier that acquires the different window coefficients from the window memory and performs an operation.

The acquired signal may be a signal of L5 frequency domain.

In another aspect of the present disclosure, there is provided a permutation and filtering method of an inverse sparse fast Fourier transform comprising giving, by a signal processing device, an index to an acquired signal; checking, by the signal processing device, whether signal information stored in an address ROM storing signal information based on a predetermined first permutation parameter and a predetermined second permutation parameter matches the index given to the acquired signal; determining, by the signal processing device, which signal acquired is multiplied by which window coefficient based on a signal output from the address ROM to perform a multiplication of the acquired signal and the window coefficient; and storing, by the signal processing device, an output of the performed multiplication in an appropriate buffer and an appropriate address based on the signal output from the address ROM.

The signal information may include input index information for comparison with the index of the acquired signal, iteration position information indicating which iteration position the acquired signal is stored in, and a window bucket position indicating which window coefficient the acquired signal is multiplied by and is stored in which address of which buffer.

The predetermined first permutation parameter and the predetermined second permutation parameter may be determined so that a minimum number of multipliers are used by repeating the permutation and filtering.

The different window coefficients may include enable indicating information about whether a corresponding shift value is used; addition or subtraction indicating information about whether to perform an addition or a subtraction after a corresponding shift is performed; and a shift amount indicating information about how much the shift is to be performed.

The enable, the addition or subtraction, and the shift amount may be determined using a filter redesigning method through the limited MSD representation.

The two multipliers may perform a multiplication using the minimal signed digit (MSD) representation representing the number in the limited nonzero digits.

Each of the two multipliers may only include a barrel shifter and an adder and may be a shift-and-add multiplier that acquires the different window coefficients from the window memory and performs an operation.

In another aspect of the present disclosure, there are provided one or more non-transitory computer-readable mediums storing one or more instructions, wherein the one or more instructions executable by one or more processors perform permutation and filtering of an inverse sparse fast Fourier transform, wherein the one or more instructions are configured to give an index to an acquired signal; check whether signal information stored in an address ROM storing signal information based on a predetermined first permutation parameter and a predetermined second permutation parameter matches the index given to the acquired signal; determine which signal acquired is multiplied by which window coefficient based on a signal output from the address ROM to perform a multiplication of the acquired signal and the window coefficient; and store an output of the performed multiplication in an appropriate buffer and an appropriate address based on the signal output from the address ROM.

Embodiments can achieve a memory reduction of 86.7% and a latency reduction of 8.3% and can increase the processing speed of permutations and filtering required for GPS signal processing using efficient hardware resources through a multiplier only including a barrel shifter and an adder.

Embodiments can provide communication of the same or similar quality as an existing one while efficiently performing permutations and filtering.

### BRIEF DESCRIPTION OF THE DRAWINGS

FIG. 1 is a conceptual diagram illustrating two loops of a sparse fast Fourier transform.

(a) and (b) of FIG. 2 are conceptual diagrams explaining the background behind the introduction of a signal processing device and a permutation and filtering method according to an embodiment.

FIG. 3 illustrates an existing hardware architecture performing permutation and filtering.

FIG. 4 illustrates a hardware architecture performing permutation and filtering according to an embodiment.

FIG. 5 illustrates a format of data stored in an addressing memory according to an embodiment.

FIG. 6 illustrates a multiplier used in hardware according to an embodiment.

FIG. 7 illustrates a format of data stored in a window memory according to an embodiment.

FIG. 8 is a flowchart illustrating a permutation and filtering method according to an embodiment.

### DETAILED DESCRIPTION

Reference will now be made in detail to embodiments of the present disclosure, examples of which are illustrated in the accompanying drawings. Detailed descriptions of known arts will be omitted if such may mislead embodiments of the present disclosure. The terms described below are terms defined in consideration of their functions in the present disclosure, and may vary depending on the intention or custom of users or operators. Therefore, their definitions should be based on the contents of the present disclosure as a whole. The terms used in the detailed description are only for the purpose of describing embodiments of the present disclosure, and should not be construed as limiting in any way. Unless expressly used otherwise, singular forms include plural forms. In the present disclosure, the words “including” or “comprising” are intended to refer to certain features, numbers, steps, operations, elements, portions or combinations thereof, and should not be construed to exclude the presence or possibility of one or more other features, numbers, steps, operations, elements, portions or combinations thereof other than those described.

Terms including ordinal numbers such as “first,” “second,” etc. may be used to describe various components, but the components are not limited by the terms. The terms may be used only in a nominal sense to distinguish one component from another component, and the ordinal meaning between them is determined through the context of the description, not through the names.

The term “and/or” is used to include all instances of combinations of the plural items being referred to. For example, “A and/or B” means all three instances of “A”, “B”, “A and B”, etc.

It should be understood that when a component is described as being “connected to” or “coupled to” other component, the component may be directly connected or coupled to the other component or intervening component(s) may be present.

Hereinafter, specific embodiments of the present disclosure will be described with reference to the drawings. The following detailed description is provided to help a comprehensive understanding of methods, devices, and/or objects described in the present disclosure. However, this is merely an example and the present disclosure is not limited thereto.

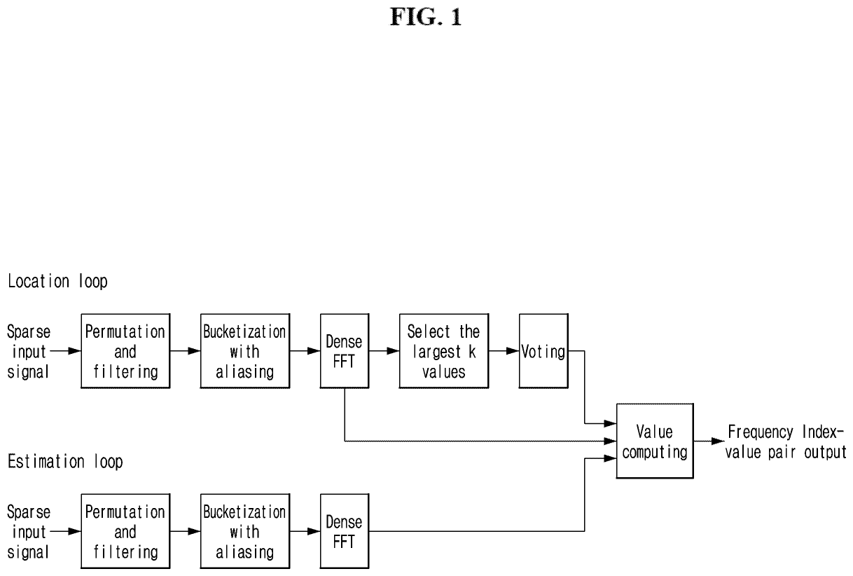

FIG. 1 is a conceptual diagram illustrating two loops of a sparse fast Fourier transform (SFFT).

A sparse fast Fourier transform (SFFT) includes a location loop and an estimation loop. The sparse FFT uses data coming from the location loop and the estimation loop to obtain information on valid k frequencies. The location loop may include steps of permutation and filtering, Bucketization with aliasing, Dense FFT, Select the largest k values, and Voting.

In the permutation and filtering step, an input is mixed according to a first parameter σ and a second parameter τ, which are permutation parameters, and then is multiplied by a window coefficient to perform filtering.

The window coefficient represents a coefficient of a window function used for the filtering.

In the step of Bucketization with aliasing, values are aliased and stored in a bucket for the filtered input.

In the Dense FFT step, B-point FFT is performed on a signal on which Bucketization with aliasing is completed.

In the step of Select the largest k values, k buckets with the largest absolute value are selected from FFT results.

In the voting step, a vote is made on a location of a frequency included in the selected bucket.

The location loop repeats the above-described process by the number of iterations of the location loop. The location loop estimates that there is a valid value at a location that has received more than a certain number of votes and outputs it as an output, and the output is a location of a frequency at which it is estimated that there is the valid value.

The estimation loop may begin after the location loop is all over. The three steps of the estimation loop (the permutation and filtering step, the Bucketization with aliasing step, the Dense FFT step) are the same as the operation of the location loop, but use different parameters. The estimation loop also repeats three steps by the number of iterations of the estimation loop.

In FIG. 1, value computing is a step of obtaining an FFT value of a location where it is estimated that there will be a valid value obtained in the location loop. The sparse fast Fourier transform obtains an original value by dividing the result of the dense FFT obtained in each loop by the window coefficient multiplied when the corresponding FFT is obtained. As a result, an output for a location and value for a valid frequency is obtained.

The sparse fast Fourier transform satisfies the following Equation 1 for the error.

$${( max ( {\hat{x}}^{′} - \hat{x} ) )}^{2} \leq \frac{ϵ}{k} \times {\sum }_{i = 0}^{n - k - 1} {\hat{x}}_{- {s}_{i}}^{2} + {{δ}^{2} ( {\sum }_{i = 0}^{n - 1} \vert {\hat{x}}_{l} \vert )}^{2} \qquad [ Equation 1 ]$$

(where \hat{x} denotes a fast Fourier transform of x, \hat{x}′ denotes an output of an algorithm, \hat{x} denotes an approximate value, δ denotes an accuracy parameter of a filter, ε denotes a parameter of the filter, \hat{x}₋ₛ denotes a remaining portion excluding a portion with a significant value from the fast Fourier transform of x, and max (\hat{x}′−\hat{x}) denotes a largest difference value between an actual frequency domain value of k valid values and a value obtained through SFFT.)

In Equation 1, a left term on the right side means a noise term and indicates an influence on a noise value excluding k valid inputs. In Equation 1, a right term on the right side means a spike term and indicates an influence on the k valid values.

(a) and (b) of FIG. 2 are conceptual diagrams explaining the background behind the introduction of a signal processing device and a permutation and filtering method according to an embodiment.

Referring to (a) of FIG. 2, a FFT algorithm multiplies a FFT of a received signal by a FFT of a code and selects an IFFT of a resultant signal. The output of the IFFT spikes when synchronizing the code with a satellite signal.

An L1 frequency used for GPS is short in length, and thus an existing IFFT is used without performing an ISFFT for acquiring an L1 frequency signal. That is, the permutation and filtering step of the ISFFT has a very long performance time, and thus a performance gain obtained by using the ISFFT in a short-length FFT GPS signal is small.

However, acquisition of GPS signals having a long FFT length, such as L5 frequency, has a long IFFT performance time, and thus improvement in performance that can be expected using the ISFFT is large. Therefore, embodiments propose a device and method for improving the permutation and filtering step to efficiently use the ISFFT at the L5 frequency.

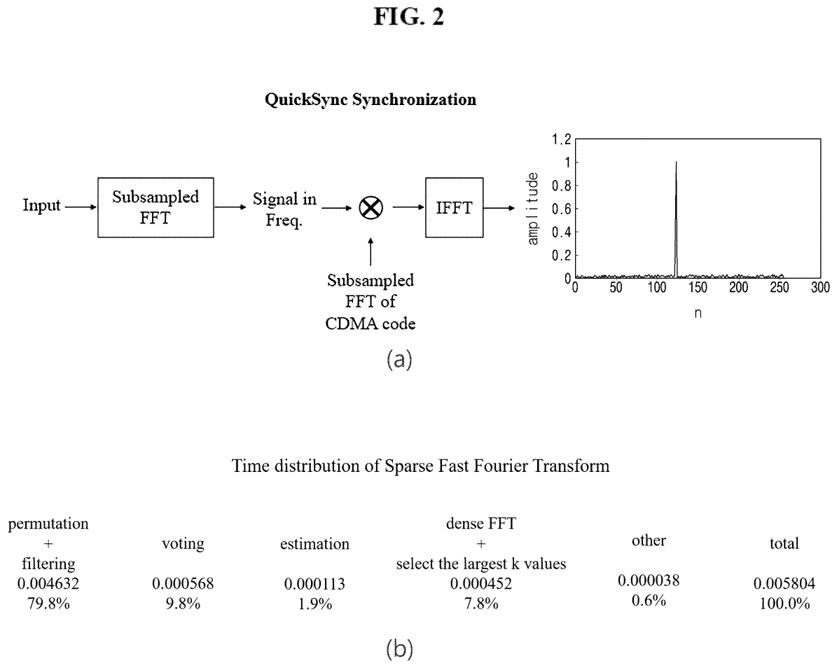

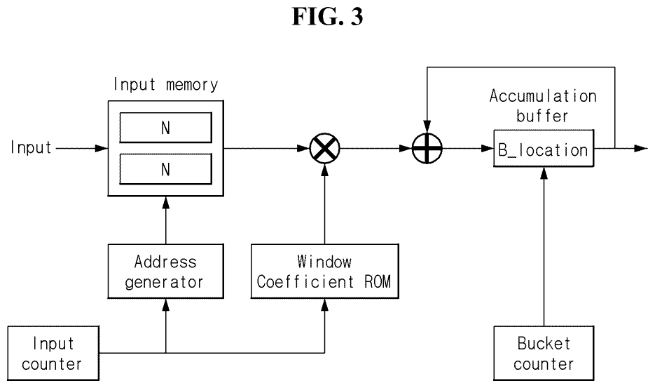

FIG. 3 illustrates an existing hardware architecture performing permutation and filtering.

The existing hardware for performing the permutation and filtering is described from a memory perspective. Parameters of GPS L5 frequency are N=16384, k=1, window coefficient ROM=538, and B_location=64. Since the hardware of FIG. 3 further includes two memories, the size of the total memories is 2*16384+538+64=33370.

Explaining the existing hardware performing the permutation and filtering from a latency perspective, the total latency is 16384+1481=17865.

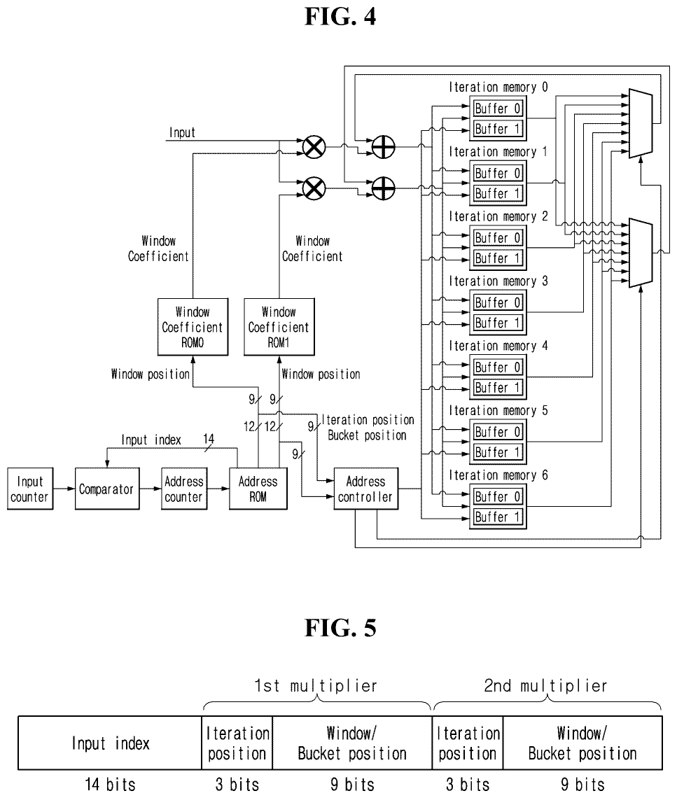

FIG. 4 illustrates a hardware architecture performing permutation and filtering according to an embodiment.

A hardware structure according to an embodiment is described from a memory perspective. Parameters of GPS L5 frequency are N=16384, k=1, window coefficient ROM=538+59=597, B_location=64, B_estimation=16, and Address ROM=3324. Thus, the size of the total memories is 597+64*6+16*8+3324=4433.

Explaining the hardware structure according to an embodiment from a latency perspective, the total latency is 16384.

Accordingly, it can be seen that the hardware structure of the embodiment reduces the memory by 86.7% and the latency by 8.3% compared to the existing structure as shown in Table 1 below.

TABLE 1

| | Conventional | Our proposed | |
|---|---|---|---|
| | permutation and | permutation and | |
| | filtering | filtering | |
| Memory | 33370 | 4433 | −86.7% |
| Latency | 17865 | 16384 | −8.3% |

Referring to FIG. 3 and FIG. 4, a difference between the existing hardware structure and the hardware structure of an embodiment is described. The hardware structure of the embodiment does not include an input memory, and thus can also reduce the latency while reducing the memory size required for the permutation and filtering.

Referring to FIG. 4, a signal processing device performing permutation and filtering according to an embodiment may include an input counter giving an index to an acquired signal, an address ROM that stores signal information based on a first permutation parameter and a second permutation parameter used for data order change, a comparator that checks whether the index given to the acquired signal matches the signal information stored in the address ROM, an address counter that transmits an output signal to the address ROM when the comparator acquires a matching signal, and counts the number of transmissions, a window memory that acquires different signals from the address ROM and outputs different window coefficients, and two multipliers that multiply the acquired signals by the window coefficients and output the signals.

The input counter is a counter that gives a number (e.g., an index) to a signal input and counts the number. For example, the input counter may count by incrementing the number by one each time the signal input enters.

The comparator may check or determine whether the order of inputs (e.g., an index) matches signal information (e.g., input index) stored in the address ROM.

The address counter may control an output of the address ROM and count by incrementing the number by one when the comparator transmits the matching signal.

The address ROM may store data based on signal information for all signal input order based on a predetermined first permutation parameter σ and a predetermined second permutation parameter τ.

When the first permutation parameter σ and the second permutation parameter τ are determined, it is determined which input is multiplied by which window coefficient in which iteration and is stored in which buffer.

In an embodiment, the smallest number of multipliers pre-select the first permutation parameter σ and the second permutation parameter τ which can implement the permutation and filtering structure.

The process of selecting the first permutation parameter σ and the second permutation parameter τ is as follows.

1) Select arbitrarily the σ and the τ. 2) Calculate a permutation result using the σ and the τ selected in the 1). 3) Determine how many multipliers are used at most based on the calculation result of the 2). 4) Repeat the 1) to 3) to find the σ and the τ that minimize the number of multipliers required.

In an embodiment, the permutation and filtering are performed using the first permutation parameter σ and the second permutation parameter τ pre-determined through the above-described process.

In an embodiment, the first permutation parameter σ and the second permutation parameter τ are selected using up to two multipliers.

The signal information may include input index information for comparison with the index of the acquired signal, iteration position information indicating which iteration position the acquired signal is stored in, and window position information (window bucket position) indicating which window coefficient the acquired signal is multiplied by and is stored in which address of which buffer.

FIG. 5 illustrates a format of data stored in an addressing memory according to an embodiment.

FIG. 5 illustrates data included in the signal information of an embodiment. The input index includes information about which input is used. The iteration position includes information about which iteration position the input is stored in after being multiplied. The window bucket position includes information about which window coefficient the input is multiplied by, and information about which buffer and which address it should be stored in after the operation is completed. The bucket position may be expressed as ‘(Window position) mod (Bucket size)’.

Since all the bucket sizes are a power of 2, the bucket position can obtain information using some bits of the window position. For example, since the bucket size is 64 in the location loop, 6 bits including the least significant bit (LSB) of the window position may be used. For example, since the bucket size is 16 in the estimation loop, 4 bits including the LSB of the window position may be used.

The window memory (window coefficient ROM) is a ROM in which a coefficient of a window function of a filter is stored. Since the window memory must receive two different addresses and output different outputs, two ROMs may be used.

The address counter may generate a control signal so that the correct value can be stored in the memory based on the iteration position information and the bucket position information of the address ROM.

That is, the operation steps of the hardware structure of an embodiment illustrated in FIG. 4 are described again. In the permutation and filtering step, based on the pre-determined first permutation parameter σ and the pre-determined second permutation parameter τ, which input is multiplied by which window coefficient in which iteration and is stored in which buffer and which address are determined.

In an embodiment, the first permutation parameter σ and the second permutation parameter τ are determined so that the minimum number of multipliers are used to minimize the hardware increase. Since the first permutation parameter σ and the second permutation parameter τ are used, two multipliers are used in an embodiment.

According to the hardware performing the permutation and filtering according to an embodiment, pre-calculate data are multiplied for the acquired signal, i.e., the input with an arbitrary number, store it in the address ROM, multiply it by an appropriate window coefficient based on the signal information each time an input enters, and then store it in an appropriate buffer location at an appropriate iteration.

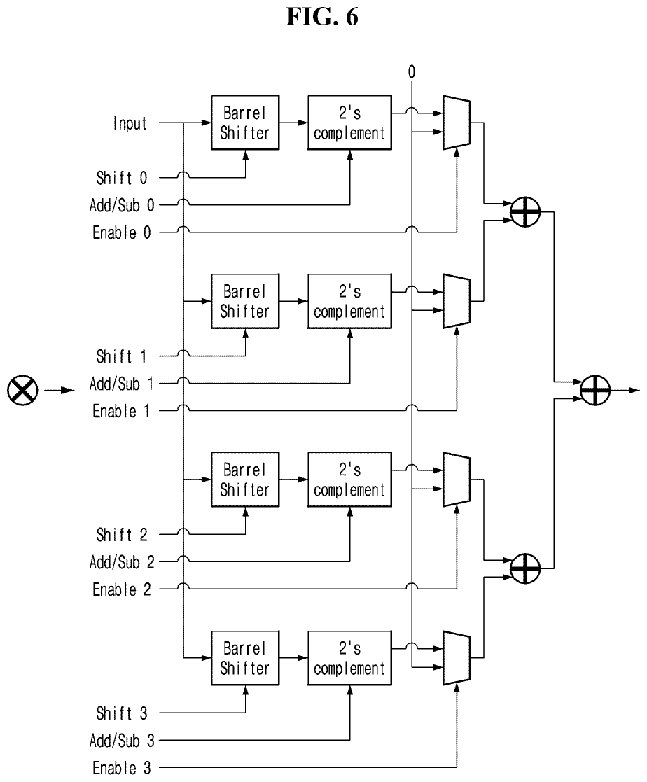

FIG. 6 illustrates a multiplier used in hardware according to an embodiment.

Referring to FIG. 6, the hardware according to an embodiment may use a multiplier for minimizing hardware resources.

A multiplier according to an embodiment may perform multiplication using a minimal signed digit (MSD) representation representing a number in nonzero digits.

If the number is represented by 0 and 1 in the existing binary representation, the number is represented by 1, 0, and −1 in the signed digit representation. In this case, there are multiple methods of representing a single number, and a method of representing the number with the smallest number of nonzero digits is a minimal signed digit representation.

The reason why the MSD representation is important is that the number of operands for addition decreases as the number of nonzero digits decreases.

In an embodiment, the filter is redesigned using a limited MSD representation to minimize the increase in multiplier hardware. As illustrated in FIG. 6, in an embodiment, the multiplier is implemented using only a barrel shifter and an adder to reduce resources.

The limited MSD representation means a representation that limits the number of nonzero digits. In an embodiment, the window coefficient is represented using up to n nonzero digits. Up to four nonzero digits are used in application techniques of an embodiment.

The redesign of a multiplier filter according to an embodiment can be summarized in the following three steps of 1) representing all the window coefficients using the MSD representation, 2) after they are represented using the MSD representation, using the corresponding representation for values with 4 or less nonzero digits, and 3) if the number of nonzero digits exceeds 4, replacing it with a value that is closest to the corresponding window coefficient among the numbers that can be represented by four nonzero digits.

A redesign algorithm of the filter can be represented by Equation 2 below.

$${min}_{x} \vert G - wx \vert \qquad [ Equation 2 ]$$

$$w = [ \begin{matrix}{2}^{0} \\ {2}^{1} \\ {2}^{2} \\ ⋮ \\ {2}^{n - 1}\end{matrix} ] x = [ \begin{matrix}{x}_{0} \\ {x}_{1} \\ {x}_{2} \\ ⋮ \\ {x}_{n - 1}\end{matrix} ]$$

$${x}_{k} = - 1 or 0 or 1 {\sum }_{k = 0}^{n - 1} \vert {x}_{k} \vert \leq 4$$

$$( where G denotes a filter )$$

A hardware structure of a shift-and-add multiplier according to an embodiment is described. In the multiplication of A×B, A is represented in binary representation and B is represented in SD representation. In the SD representation, there are three signals in total: 1) Shift, 2) Add-Subtract, and 3) Enable.

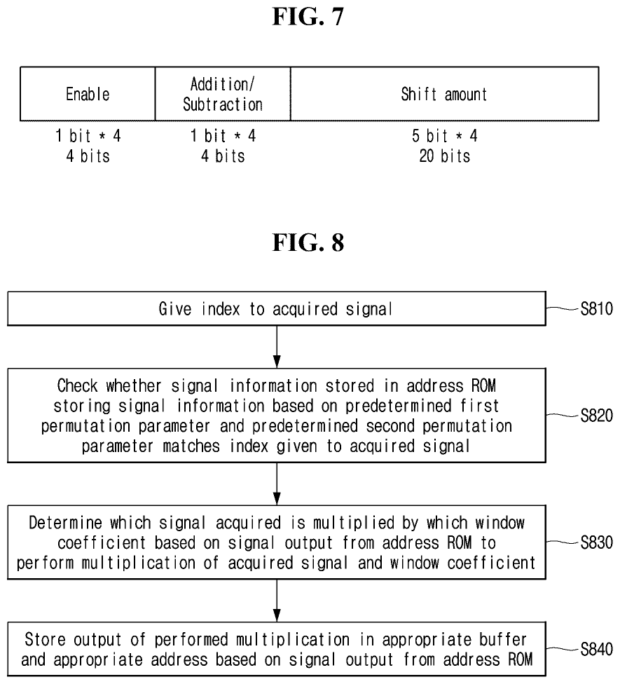

FIG. 7 illustrates a format of data stored in a window memory according to an embodiment.

A window memory may store data of different window coefficients replaced by the minimal signed digit (MSD) representation.

Referring to FIG. 7, data stored in the window memory may include Enable indicating whether the corresponding shift value is used (e.g., 0: not used, 1: used); Addition/Subtraction indicating whether to perform addition or subtraction after the corresponding shift is performed (e.g., 0: addition, 1: subtraction); and Shift amount indicating information about how much the shift is to be performed (e.g., 5 bits are used since shifts from 0 to 31 are possible).

In the shift-and-add multiplier hardware of an embodiment, 1) A is shifted in the barrel shifter by a shift amount; 2) complementation is performed by the Add/Subtract signal; and 3) when this signal is used by the Enable signal, the signal of 2) is selected, and when this signal is not used, 0 is selected and connected to the adder.

In other words, the shift-and-add multiplier hardware of an embodiment receives the operand of the shift operation and the shift amount as input from the barrel shifter, shifts the value of the operand by the shift amount, and performs a 2's complement operation. Then, it adds up all the outputs for which the complement operation is completed.

The validity of the MSD representation of an embodiment is described using Equation 1 described above.

$${( max ( {\hat{x}}^{′} - \hat{x} ) )}^{2} \leq \frac{ϵ}{k} \times {\sum }_{i = 0}^{n - k - 1} {\hat{x}}_{- {s}_{i}}^{2} + {{δ}^{2} ( {\sum }_{i = 0}^{n - 1} \vert {\hat{x}}_{l} \vert )}^{2} \qquad [ Equation 1 ]$$

In Equation 1, a left term on the right side means a noise term and indicates an influence on a noise value excluding k valid inputs. In Equation 1, a right term on the right side means a spike term and indicates an influence on the k valid values.

If the filter is redesigned based on the MSD representation, the value of 8 increases, which affects the size of the error of SFFT. However, due to the nature of the application field called GPS, the SNR is not large, so the influence of the noise term is dominant compared to the spike term. Therefore, the change in the value of 8 due to the MSD representation redesign of the filter is very small in the spike term compared to the noise term, and thus does not affect the performance of SFFT.

If the hardware structure is designed in the existing method, the number of multipliers doubles. In an embodiment, the multiplier is implemented as the shift-and-add multiplier, and multiplication is implemented using only the shifter and the adder. In summary, it is as shown in Table 2 below.

TABLE 2

| | Conventional | Our Method | Our Method |
|---|---|---|---|
| | SFFT with | with | with shift |
| | conventional | conventional | and add |
| | multiplier | multiplier | multiplier |
| Multiplier | 1 | 2 | 0 |
| Barrel shifter | 0 | 0 | 8 |
| Adder | 0 | 0 | 6 |

As described above, the hardware for performing the permutation and filtering according to an embodiment can efficiently perform permutation and filtering essential to an inverse sparse FFT algorithm that can be used for GPS acquisition.

The hardware structure according to an embodiment has a memory reduction of 86.7% and a latency reduction of 8.3% compared to the existing structure.

In an embodiment, in order to minimize the increased hardware resources due to the new structure, the filter was redesigned based on the MSD representation using four nonzero digits, and the multiplier was replaced with the shift-and-add multiplier using this. Due to the MSD representation and the shift-and-add multiplier, it was shown that eight barrel shifters and six adders were used instead of two multipliers.

FIG. 8 is a flowchart illustrating a permutation and filtering method according to an embodiment.

Referring to FIG. 8, a permutation and filtering method according to an embodiment may include a step S810 in which a signal processing device gives an index to an acquired signal, a step S820 in which the signal processing device checks whether signal information stored in an address ROM storing signal information based on a predetermined first permutation parameter and a predetermined second permutation parameter matches the index given to the acquired signal, a step S830 in which the signal processing device determines which signal acquired is multiplied by which window coefficient based on a signal output from the address ROM, and performs a multiplication of the acquired signal and the window coefficient, and a step S840 in which the signal processing device stores an output of the performed multiplication in an appropriate buffer and an appropriate address based on the signal output from the address ROM.

The acquired signal may be a signal in the L5 frequency domain.

The signal information may include input index information for comparison with the index of the acquired signal, iteration position information indicating which iteration position the acquired signal is stored in, and window position information (window bucket position) indicating which window coefficient the acquired signal is multiplied by and is stored in which address of which buffer.

Embodiments of the present disclosure can be implemented by various means, for example, hardware, firmware, software, or combinations thereof. When embodiments are implemented by hardware, one embodiment of the present disclosure can be implemented by one or more application specific integrated circuits (ASICs), digital signal processors (DSPs), digital signal processing devices (DSPDs), programmable logic devices (PLDs), field programmable gate arrays (FPGAs), processors, controllers, microcontrollers, microprocessors, and the like. When embodiments are implemented by firmware or software, one embodiment of the present disclosure can be implemented by modules, procedures, functions, etc. performing functions or operations described above. Software code can be stored in a memory and can be driven by a processor. The memory is provided inside or outside the processor and can exchange data with the processor by various well-known means.

Embodiments of the present disclosure can be implemented as computer-readable codes on a computer-readable recording medium. The computer-readable recording medium includes all types of recording devices in which data readable by a computer system is stored.

Examples of the computer-readable recording medium include a ROM, a RAM, a CD-ROM, a magnetic tape, a floppy disk, an optical data storage device, etc. Further, the computer-readable recording medium may be distributed to computer systems connected over a network, and computer-readable codes may be stored and executed in a distributed manner. Functional programs, codes, and code segments for implementing embodiments of the present disclosure can be easily construed by programmers skilled in the art to which the present disclosure pertains.

The foregoing description of the present disclosure is intended to be illustrative, and a person having an ordinary skill in the art to which the present disclosure pertains can understand that other specific forms can be easily modified without changing the technical idea or essential features of the present disclosure. Therefore, it should be understood that the embodiments described above are illustrative in all aspects and are not restrictive.

The scope of the present disclosure is defined by the following claims rather than by the foregoing detailed description, and all changes or modifications resulting from the meaning and scope of the claims and their equivalents are to be construed as being encompassed by the scope of the present disclosure.

What is claimed is:

1. A signal processing device for an inverse sparse fast Fourier transform performing permutation and filtering, the signal processing device acquiring a signal and converting the acquired signal into a time domain, the signal processing device comprising:
an input counter configured to give an index to the acquired signal;
an address ROM configured to store signal information based on a predetermined first permutation parameter and a predetermined second permutation parameter used for a data order change;
a comparator configured to check whether the index given to the acquired signal matches the signal information stored in the address ROM;
an address counter configured to transmit an output signal to the address ROM when the comparator acquires a matching signal, and count a number of transmissions;
a window memory configured to acquire different signals from the address ROM and output different window coefficients replaced in a minimal signed digit (MSD) representation representing a number in limited nonzero digits; and
two multipliers configured to multiply the acquired signals by the window coefficients and output the signals.

2. The signal processing device of claim 1, wherein the predetermined first permutation parameter and the predetermined second permutation parameter are determined so that a minimum number of multipliers are used by repeating the permutation and filtering.

3. The signal processing device of claim 1, wherein the signal information includes input index information for comparison with the index of the acquired signal, iteration position information indicating which iteration position the acquired signal is stored in, and a window bucket position indicating which window coefficient the acquired signal is multiplied by and is stored in which address of which buffer.

4. The signal processing device of claim 1, wherein the different window coefficients include enable indicating information about whether a corresponding shift value is used; addition or subtraction indicating information about whether to perform an addition or a subtraction after a corresponding shift is performed; and a shift amount indicating information about how much the shift is to be performed.

5. The signal processing device of claim 4, wherein the two multipliers perform a multiplication using the minimal signed digit (MSD) representation representing the number in the limited nonzero digits.

6. The signal processing device of claim 5, wherein each of the two multipliers only includes a barrel shifter and an adder and is a shift-and-add multiplier that acquires the different window coefficients from the window memory and performs an operation.

7. A permutation and filtering method of an inverse sparse fast Fourier transform comprising:
giving, by a signal processing device, an index to an acquired signal;
checking, by the signal processing device, whether signal information stored in an address ROM storing signal information based on a predetermined first permutation parameter and a predetermined second permutation parameter matches the index given to the acquired signal;
determining, by the signal processing device, which signal acquired is multiplied by which window coefficient based on a signal output from the address ROM to perform a multiplication of the acquired signal and the window coefficient; and
storing, by the signal processing device, an output of the performed multiplication in an appropriate buffer and an appropriate address based on the signal output from the address ROM.

8. The permutation and filtering method of claim 7, wherein the predetermined first permutation parameter and the predetermined second permutation parameter are determined so that a minimum number of multipliers are used by repeating the permutation and filtering.

9. The permutation and filtering method of claim 7, wherein the signal information includes input index information for comparison with the index of the acquired signal, iteration position information indicating which iteration position the acquired signal is stored in, and a window bucket position indicating which window coefficient the acquired signal is multiplied by and is stored in which address of which buffer.

10. One or more non-transitory computer-readable mediums storing one or more instructions,
wherein the one or more instructions executable by one or more processors perform permutation and filtering of an inverse sparse fast Fourier transform,
wherein the one or more instructions are configured to:
give an index to an acquired signal;
check whether signal information stored in an address ROM storing signal information based on a predetermined first permutation parameter and a predetermined second permutation parameter matches the index given to the acquired signal;
determine which signal acquired is multiplied by which window coefficient based on a signal output from the address ROM to perform a multiplication of the acquired signal and the window coefficient; and
store an output of the performed multiplication in an appropriate buffer and an appropriate address based on the signal output from the address ROM.
